(19) United States
(12) Patent Application Publication
(10) Pub. No.: US 2026/0103118 A1
(43) Pub. Date: Apr. 16, 2026

(54) VEHICLE SEAT HAVING INTEGRATED WEIGHT DETECTION

(71) Applicant: BROSE FAHRZEUGTEILE SE & CO. KOMMANDITGESELLSCHAFT, COBURG, Coburg (DE)

(72) Inventors: Alexander CZEMPIK, Markkleeberg (DE); Alexander MÜLLER, Bischberg (DE); Alex KROMER, Stegaurach (DE); Florian POHL, Ebersdorf (DE); Stefan SCHULZE, Rödental (DE)

(21) Appl. No.: 19/113,818

(22) PCT Filed: Sep. 19, 2023
(86) PCT No.: PCT/EP2023/075857

§ 371 Date: Apr. 25, 2025

(30) Foreign Application Priority Data
Sep. 20, 2022 (DE) 10 2022 209 892.7

(51) Int. Cl. B60N 2/00; B60N 2/02; B60N 2/16

(52) U.S. Cl. CPC B60N 2/0025; B60N 2/02253; B60N 2/02258; B60N 2/0272; B60N 2/1615; B60N 2/164; B60N 2210/24

(57) ABSTRACT

A vehicle seat comprising a seat part assembly, a floor assembly carrying the seat part assembly, and a height adjustment device for adjusting a distance between the seat part assembly and the floor assembly by means of a drive device. The vehicle seat furthermore comprises a control system coupled to the drive.

### CROSS REFERENCE TO RELATED APPLICATIONS

The present application is a U.S. National Phase of International Application No. PCT/EP2023/075857 entitled “VEHICLE SEAT HAVING INTEGRATED WEIGHT DETECTION,” and filed on Sep. 19, 2023. International Application No. PCT/EP2023/075857 claims priority to German Patent Application No. 10 2022 209 892.7 filed on Sep. 20, 2022. The entire contents of each of the above-listed applications are hereby incorporated by reference for all purposes.

### BACKGROUND

The proposed solution relates to a vehicle seat, a system comprising the vehicle seat, a method, a corresponding computer program product, and a non-volatile computer-readable storage medium.

Some functions in present-day vehicles are based on the detection of a seat occupation. When a vehicle seat is occupied, controllers in the vehicle regularly check whether the corresponding safety belt also is applied. Furthermore, the activation of air bags can be coupled to the seat occupation. In some cases, such or further functions can be improved when it is not only detected whether or not the vehicle seat is occupied in any way, but when the weight acting on the vehicle seat also is indicated. For example, an alarm for a non-applied safety belt can be omitted when the vehicle seat is occupied by an object (e.g. by a bag), but not by a passenger. Moreover, the activation of air bags can be adapted to the weight of the passenger in order to achieve an optimized restraining effect.

In practice, for example, so-called bladder mats or piezo elements can be embedded in a seat part in order to detect a seat occupation and carry out an approximate weight measurement. Such components, however, require installation space and render manufacture expensive, among other things due to additional cabling.

DE 10 2006 061 669 A1 describes a method for determining an information on the occupation weight of a vehicle seat, wherein a seat element of the vehicle seat can be adjusted by means of a drive unit, comprising the following steps: providing at least one measurement signal which represents a state of the drive unit; actuating the drive unit for at least a predetermined time period; during the time of actuation, detecting the measurement signal, determining a load moment from the measurement signal according to a motor model; and determining an information on the occupation weight of the seat element in dependence on the load moment. An electric drive unit can be provided for the adjustment of the seat height. However, it turned out that the accuracy of the measurement needs to be improved.

DE 10 2017 217 331 A1 describes a method for operating an electromotive massage device of a seat, in particular of a motor vehicle, which comprises a massage drive with an electric motor, in which the electric motor is energized, a torque of the electric motor is detected and a reference value is determined therefrom, and based on the reference value an occupation of at least one portion of the seat is determined.

DE 103 35 734 A1 relates to a method for the seat occupation detection for a motor vehicle with at least one actuator for seat adjustment. The supply of electric power for the one or more actuators for seat adjustment is detected during their actuation and evaluated as a measure for the seat occupation. The accuracy of this measurement, too, however has potential for improvement.

### SUMMARY

The object is to improve the weight detection in vehicle seats.

This object is achieved by a vehicle seat with features as described herein.

Accordingly, a vehicle seat comprises a seat part assembly, a floor assembly carrying the seat part assembly, and a height adjustment device for adjusting a distance between the seat part assembly and the floor assembly by means of a drive device. It is provided that the vehicle seat furthermore comprises a control system coupled to the drive device in terms of control technology, which control system is adapted to carry out the following steps: activating the drive device for adjusting (e.g. for increasing or reducing) the distance between the seat part assembly and the floor assembly in a first direction (e.g. up or down); detecting a value of a parameter of the height adjustment device and/or of the drive device during the adjustment in the first direction; activating the drive device for adjusting (e.g. correspondingly for reducing or increasing) the distance between the seat part assembly and the floor assembly in a second direction opposite to the first direction (e.g. correspondingly down or up); detecting a value of the parameter of the height adjustment device and/or of the drive device during the adjustment in the second direction; and determining a weight acting on the seat part assembly based on the detected values of the parameter.

This is based on the idea that a height adjusting motor causes a torque due to the adjustment, which corresponds to a current. This current can be measured via the control system (which can comprise an electronic unit arranged on the vehicle seat and/or a central vehicle control unit) and can be utilized for evaluating the load increase. Furthermore, the described solution is based on the finding that frictions and tolerances can impair the accuracy of the weight measurement, that a measurement in both adjustment directions however allows to offset such influences. In this way, a particularly precise weight determination can be achieved with a very simple construction.

The parameter can be an electrical parameter, in particular a current intensity, a voltage, or a power. Alternatively or in addition, it can be provided that the parameter indicates a torque. Alternatively or in addition, it can be provided that the parameter indicates a rotational speed (e.g. of the drive device), in particular the rotational speed maximally achieved during the adjustment. These parameters allow a simple conversion into a weight, e.g. by means of a conversion rule and/or a table (Lookup Table, LUT). The parameter in particular can relate to one or more drive motor(s) of the drive device. Optionally, the control system is adapted (for each of the two directions) to increase a voltage and/or a current intensity of the drive device proceeding from a starting value (e.g. zero), until a component of the height adjustment device, in particular a drive motor of the drive device, is put into movement from a standstill. The value of the parameter then for example is the reached value of the current intensity or voltage. The control system furthermore can be adapted to stop the drive device as soon as it has registered the movement. The weight measurement thus can be achieved with an only minimal movement. The adjustment in the first and second direction thus is only minimal and hardly or not noticeable for a seat user.

Furthermore, it can be provided that the parameter indicates an adjustment path covered within a certain (in particular predetermined) time, in particular the length of this adjustment path, or an adjustment time needed for a certain (in particular predetermined) adjustment path. These parameters also allow a simple conversion into a weight, e.g. by means of a conversion rule and/or an LUT.

It can be advantageous when the control system is adapted such that the detection of the at least one value of the parameter in the first direction (R1) and/or in the second direction (R2) is effected within a period of a complete revolution of a gear stage of the height adjustment device and/or the drive device. Irregularities due to a gear modulation hence can be compensated so that a more exact result can be achieved.

The control system can be adapted to activate the drive device each for a predetermined time and/or each along a specified adjustment path (e.g. measured by the number of motor rotations) in the first direction and in the second direction. For example, the power can be determined along the predetermined adjustment path or for the predetermined adjustment time and be used for determining the weight.

The drive device can be activatable with different adjustment speeds. Expressed in other words, the drive device can provide for a variable adjustment speed. The control system for example is adapted to signal an adjustment speed to the drive device. Furthermore, the drive device can have a maximum adjustment speed. For example, the drive device is operated with the maximum adjustment speed when the seat height is set. The control system can be adapted to activate the drive device with an adjustment speed in the first direction and then with this (or another) adjustment speed in the second direction, which is (each) lower than the maximum adjustment speed. The process of the weight measurement thereby is not disturbing for a seat user. In particular, the adjustment speed can (each) be less than or equal to 50 % of the maximum adjustment speed, optionally less than or equal to 10 % of the maximum adjustment speed or even less than or equal to 1 % of the maximum adjustment speed, so that the adjustment is hardly perceptible. When the drive device has a minimum adjustment speed with which it can be operated, the control system can be adapted to activate the drive device with this minimum adjustment speed in the first direction and then with the (or a) minimum adjustment speed in the second direction. The measurement can then be regarded as quasi-static.

The control system can include a storage medium in which e.g. a model is stored, which assigns a corresponding value of an acting weight to values of the parameter, in particular to every possible value of the parameter. With reference to this model (e.g. in the form of an LUT) the weight determination can be carried out in a particularly simple way. The model can also be a machine learning model which has been trained e.g. with various weight loads.

Optionally, the model each assigns a value of an acting weight to the values of the parameter (in particular to every possible value of the parameter) for several possible adjustment positions of the height adjustment device. It can thereby be taken into account that due to a kinematic of the height adjustment device an adjustment does not require the same torque in every adjustment position.

Optionally the model each assigns a value of an acting weight to the values of the parameter (in particular to every possible value of the parameter) with respect to an adjustment in the first direction on the one hand and with respect to an adjustment in the second direction on the other hand (independently of each other). Thus, the accuracy of the measurement can be further improved.

The control system for example is adapted to each separately determine the acting weight on the basis of the detected value of the parameter for the first direction and on the basis of the detected value of the parameter for the second direction. Optionally, the control system furthermore is adapted to determine the weight acting on the seat part assembly 10 from the two values of the weight thus obtained, namely concretely to form a mean value. Here, in particular a weighted mean value can be formed, for which each of the two individual values is multiplied by a weighting factor.

The parameter can be detected for a drive motor of the drive device. Optionally, the drive device comprises a plurality of drive motors. The control system can be adapted to detect a value of the parameter during the adjustment for each of the plurality of drive motors and to determine the weight acting on the seat part assembly on the basis of the detected values of the parameter of the plurality of drive motors. For this purpose, the values of the parameter for the drive motors can be added and then the weight can be determined on the basis of the added value. Alternatively, a corresponding weight acting on the seat part assembly can each separately be determined for the individual drive motors and then e.g. a mean value can be formed therefrom. As described above, the adjustment in the first direction initially is carried out and then the adjustment in the second direction. Measured values of a plurality of drive motors can further increase the accuracy of the determined weight.

The control system can be adapted to detect the values of the parameter for a calibration when no weight acts on the vehicle seat. This can be effected in the way described above, i.e. by activating the drive device for adjusting the distance between the seat part assembly and the floor assembly in the first direction and for detecting the value of the parameter of the drive device during the adjustment in the first direction; and by activating the drive device for adjusting the distance between the seat part assembly and the floor assembly in the second direction and for detecting the value of the parameter of the drive device during the adjustment in the second direction. As the weight acting on the seat part assembly is known (0 kg), the detected values can be stored as a reference and/or be used for calibration e.g. of the model. Aging-related effects, e.g. changes of efficiencies, frictions etc. during the service life of the vehicle seat, can be corrected by a calibration.

Optionally, the control system is adapted to automatically repeat the calibration after temporally specified intervals. This provides for an always high accuracy of the weight determination.

The drive device, in particular each of a plurality of drive devices, can (each) comprise a brushless direct current motor. Such motors allow a particularly good setting of the adjustment speed by setting the rotational speed. In general, the adjustment speed can be dimensioned via the rotational speed.

The control system optionally is adapted to receive data on a seat occupation of the vehicle seat from a camera or another detection device (such as a radar). The data can be camera images or other data which are evaluated by the control system, e.g. in order to determine the size of a passenger sitting on the vehicle seat and/or his position on the vehicle seat. These data can be used with the determined weight. Furthermore, the determined weight can be corrected on the basis of the data concerning the seat occupation, e.g. the position of the passenger on the vehicle seat can be used to correct a measured weight (measured too low).

According to an advantageous development, the control system can be adapted to take account of a vehicle inclination when determining a weight acting on the seat part assembly. As the inclination of the vehicle in which the vehicle seat is mounted can have an influence on the weight determination, a faulty weight determination can occur from too large a vehicle inclination. To be able to avoid this, the vehicle inclination can be taken into account as a further input value.

According to an advantageous development, the control system can be adapted to take account of a temperature when determining a weight acting on the seat part assembly. The temperature can influence certain material properties in particular of a component of the height adjustment device and/or of the drive device, so that large temperature fluctuations can also impair the determination of the weight. To be able to avoid this, the temperature can be taken into account as a further input value. For example, this can be a temperature in a vehicle interior.

According to an advantageous development, the control system can be adapted to take account of a setting of another seat adjustment device, in particular for setting a backrest angle and/or a seat inclination, when determining a weight acting on the seat part assembly. For determining a correct weight a load increase on the seat effected at the same position can be relevant. A center of gravity of the load increase on the seat can be influenced for example by a setting of another seat adjustment device. For determining an even more accurate measurement result of the weight acting on the vehicle seat it can therefore be expedient when the setting of another seat adjustment device is taken into account as a further input variable.

To be able to prevent a faulty weight measurement in a better way, it can be provided that the control system is adapted to detect whether the vehicle seat and/or an occupant sitting thereon moves during the detection of the at least one value of the parameter of the height adjustment device and/or of the drive device in the first direction and/or in the second direction due to a further action of force, in particular an action of force independent of the height adjustment device and/or the drive device. Preferably, this can be provided in such a way that an analysis of the current profile can be taken into account or is taken into account. In particular, on detection of a movement due to a further action of force, the detection of the at least one value of the parameter of the height adjustment device and/or of the drive device can be repeated and/or the previously detected value of the parameter can be discarded.

According to a development, the control system can comprise a memory in which a model is retrievably stored, with which at least a connection between the weight acting on the seat part assembly and with the input values adjustment position and value of the measured parameter is produced. The model can include further input variables, such as for example the input variables previously described herein. The model can be used for determining a weight acting on the seat part assembly. The measurement result of the weight can be the more exact the more input variables are taken into account.

The previously described features likewise can also be used for developing the method and/or system described and/or claimed herein.

According to one aspect, there is provided a system comprising the vehicle seat according to an arbitrary embodiment described herein and the camera and/or the other detection device.

According to a development of the system, it can be provided that it comprises a measuring device for measuring a setting of another seat adjustment device, in particular for setting a backrest angle and/or a seat inclination.

According to one aspect, there is provided a computer-implemented method for determining a weight acting on a vehicle seat, in particular on the vehicle seat according to an arbitrary embodiment described herein. The method comprises the following steps: activating a drive device of a height adjustment device of the vehicle seat for adjusting a distance between a seat part assembly and a floor assembly of the vehicle seat in a first direction; detecting a value of a parameter of the drive device during the adjustment in the first direction; activating the drive device for adjusting the distance between the seat part assembly and the floor assembly in a second direction opposite to the first direction; detecting a value of the parameter of the drive device during the adjustment in the second direction; and determining a weight acting on the seat part assembly based on the detected values of the parameter. As regards the advantages, reference is made to the above indications concerning the vehicle seat.

The method can comprise steps according to the various embodiments of the control system described above.

According to one aspect there is indicated a computer program product, comprising commands which on execution by one or more computers (e.g. in the form of the control system described above) cause the same to carry out the method described above.

According to one aspect there is indicated a non-volatile computer-readable storage medium on which commands are stored, which on execution by one or more computers (e.g. in the form of the control system described above) cause the same to carry out the method described above.

### BRIEF DESCRIPTION OF THE DRAWINGS

The idea underlying the solution will be explained in detail below with reference to the exemplary embodiments illustrated in the Figures.

FIG. 1 shows a schematic view of a vehicle seat comprising a height adjustment device which is carried by a floor assembly, wherein the floor assembly by way of example is configured in the form of a longitudinal adjustment device.

FIG. 2 shows a view of a seat part assembly of a vehicle seat.

FIG. 3 shows a top view of the arrangement of FIG. 2.

FIG. 4 shows a sectionally enlarged representation of the arrangement of FIG. 2, representing a drive device on a swivel element for connecting the seat part assembly to a floor assembly in the form of a longitudinal adjustment device.

FIG. 5 shows an alternatively designed drive device for the vehicle seat of FIG. 1.

FIG. 6 shows a method for determining a weight acting on the vehicle seat of FIG. 1.

### DETAILED DESCRIPTION

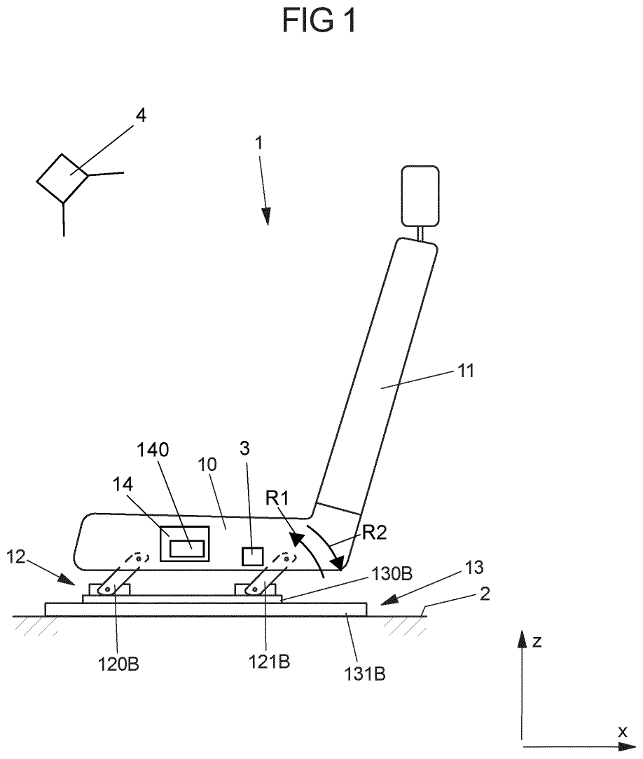

FIG. 1 shows a vehicle seat 1 which for example can be arranged as a front seat or also as a rear seat in the second or third seat row in a vehicle. The vehicle seat 1 includes a seat part assembly 10 on which a backrest part assembly 11 is tilt-adjustably arranged and which via a height adjustment device 12 is connected to a floor assembly 13 in the form of a longitudinal adjustment device for longitudinally adjusting the vehicle seat 1 along a longitudinal direction X.

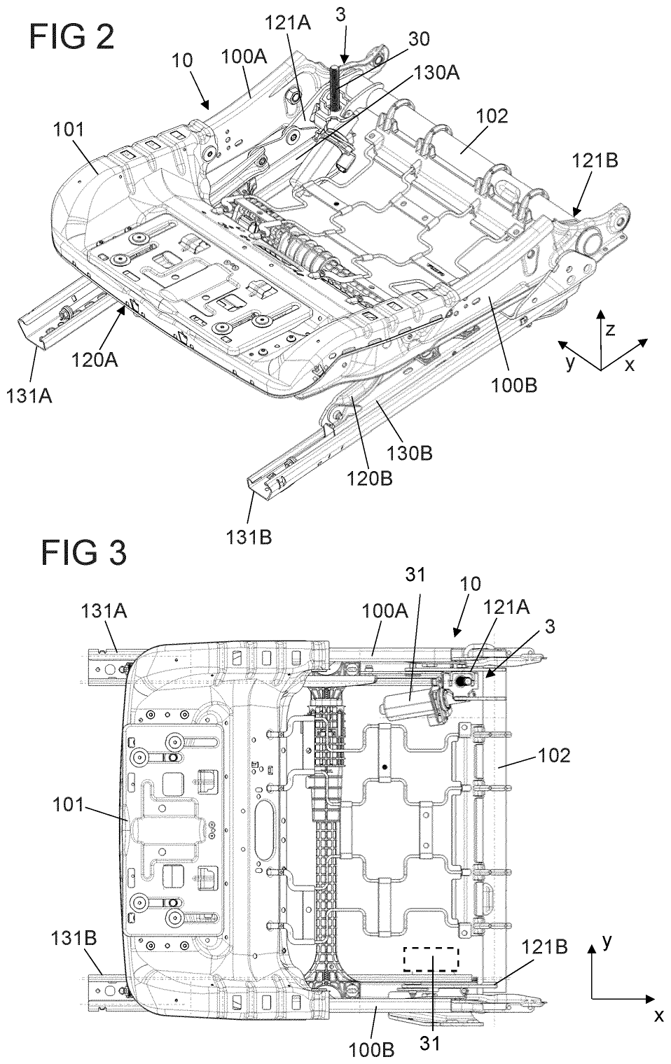

The longitudinal adjustment device 13 usually includes, as can be taken from FIG. 1 in a synopsis with FIGS. 2 and 3, two pairs of guide rails 130A, 131A, 130B, 131B which each are arranged on a side of the seat part assembly 10 and are spaced apart from each other along a transverse direction Y perpendicular to the longitudinal direction X. Lower guide rails 131A, 131B here are firmly connected to a vehicle floor 2. Upper guide rails 130A, 130B on the other hand are coupled to swivel elements 120A, 121A, 120B, 121B of the height adjustment device 12, via which the floor assembly 13 is connected to the seat part assembly 10.

The swivel elements 120A, 121A, 120B, 121B form two pairs of four-bar linkages jointly with the upper guide rails 130A, 130B and lateral frame parts 100A, 100B of the seat part assembly 10. For this purpose, the swivel elements 120A, 121A, 120B, 121B each with one end are pivotally connected to the respectively associated upper guide rail 130A, 130B and with the other end pivotally connected to the seat part assembly 10, e.g. by means of a transverse tube 102 (or another part of the seat part assembly 10) pivotally extended between the frame parts 100A, 100B of the seat part assembly 10 in such a way that by pivoting the swivel elements 120A, 121A, 120B, 121B the vertical position of the seat part assembly 10 can be changed along a vertical direction Z (perpendicular to the longitudinal direction X and the transverse direction Y). In the process, a distance between the seat part assembly 10 and the floor assembly 13 is changed. The height adjustment device 12 thus is adapted to adjust a distance between the seat part assembly 10 and the floor assembly 13. To affect an adjustment, the height adjustment device 12 comprises (at least) a drive device 3 (with one or more drive motors).

The floor assembly, i.e. here the longitudinal adjustment device 13, carries the seat part assembly 10.

The vehicle seat 1 furthermore comprises a control system 14 coupled to the drive device 3, which is adapted to carry out the following steps:
activating the drive device 3 for adjusting the distance between the seat part assembly 10 and the floor assembly 13 in a first direction R1;
detecting a value of a parameter of the drive device 3 during the adjustment in the first direction R1;
activating the drive device 3 for adjusting the distance between the seat part assembly 10 and the floor assembly 13 in a second direction R2 opposite to the first direction R1;
detecting a value of the parameter of the drive device 3 during the adjustment in the second direction R2; and
determining a weight acting on the seat part assembly 10 based on the detected values of the parameter.

According to FIG. 1, an adjustment in the first direction R1 increases the distance between the seat part assembly 10 and the floor assembly 13, while an adjustment in the second direction R2 reduces the distance between the seat part assembly 10 and the floor assembly 13. The weight determination here only requires a minimum adjustment path, e.g. of few mm with respect to the distance between the seat part assembly 10 and the floor assembly 13, so that the measurement is not or hardly noticed by a seat user.

Optionally, the measurement is carried out several times, e.g. three times in succession, and a mean value for the weight is determined. Thus, the accuracy can be further increased.

The drive device 3 can be activated with different adjustment speeds and has a minimum and a maximum adjustment speed. The control system 14 is adapted to activate the drive device 3 with the minimum adjustment speed in the first direction R1 and then in the second direction R2, alternatively with an adjustment speed which is lower than the maximum adjustment speed. The weight measurement thus is hardly perceptible by a seat user or not at all.

In the present case, the parameter is an electrical parameter, namely the current intensity through the supply line of at least one drive motor 31 of the drive device 3. Alternatively or additionally, e.g. the applied power can also be employed as a parameter. The current intensity corresponds to a respective torque (of the drive motor or the drive motors) of the drive device 3. Depending on the magnitude of the acting weight, for example by a passenger, a larger or smaller torque must be applied by the drive device 3 for an adjustment, e.g. by a specified adjustment path. Therefore, a specified relationship between the current intensity (in general the parameter) and the acting weight (possibly in dependence on the respectively instantaneous adjustment position of the height adjustment device 12) can be used by the control system 14 in order to determine the weight. By carrying out the measurement in both adjustment directions R1, R2, inaccuracies which have different effects in the different directions can be deducted, e.g. by an (optionally weighted) formation of a mean value from values of the weight determined separately for the two directions R1, R2. Inaccuracies due to frictions, tolerances, wear and the like can be deducted via empty measurements with an unoccupied vehicle seat 1. For example, the difference between a current intensity (generally: values of the parameter) is formed downwards with an empty measurement and downwards with an occupied weight measurement and then multiplied by a first factor in order to determine a weight in the measurement during the downward adjustment. Furthermore, the difference between a current intensity (generally: values of the parameter) is formed upwards with an occupied weight measurement and upwards with an empty measurement and then multiplied by a second factor in order to determine a weight in the measurement during the upward adjustment. The first factor and the second factor can be different from each other or be the same. The weight then is determined e.g. with reference to the sum of the two weight values.

The current intensity (generally: the value of the parameter) for a respective direction can be determined as a mean value along an adjustment path. Optionally, a start-up of the drive motor is excluded.

The parameter can also indicate e.g. a rotational speed maximally achieved during the adjustment, an adjustment path covered within a particular time, or an adjustment time needed for a particular adjustment path.

The specified relationship is stored e.g. in a storage medium 140. The relationship can be a model which assigns a value of an acting weight to every possible value of the current intensity. Because these relationships in the illustrated example depend on the adjustment direction, the model also each assigns a value of an acting weight to every possible value of the current intensity with respect to an adjustment in the first direction R1 and with respect to an adjustment in the second direction R2 independently of each other. And because these relationships in the illustrated example also depend on the adjustment position, the model each assigns a value of an acting weight to every possible value of the current intensity for all possible adjustment positions of the height adjustment device 12. The model can comprise an LUT and/or a trained machine learning model.

To create the LUT and/or the training data for the machine learning model, test masses (e.g. 0 kg, 10 kg, 20 kg, 40 kg and 80 kg, optionally with a finer subdivision) can be placed on the seat part assembly 10 with various known weights and the values of the parameter (in particular at several adjustment positions) can be determined in the way described above. Thus, a table with factors can be determined, which for each adjustment position assigns a value of a weight to each value of the parameter (e.g. the current intensity). This table can be stored in the storage medium. Interpolation is possible between two entries each of the table.

To make corrections in response to changes in the efficiencies and due to friction etc., the control system 14 is configured to regularly perform calibration runs. The control system 14 here is adapted to detect the values of the parameter for a calibration when no weight acts on the vehicle seat 1.

A camera 4 (or another detection device such as a radar) is aligned with the vehicle seat 1 in order to detect the size and position or the like of a passenger sitting on the vehicle seat 1 in camera images. The camera 4 directly or indirectly is communicatively connected to the control system 14 so that the control system 14 receives data on a seat occupation of the vehicle seat 1 from the camera 4. The same can be present in the form of the captured images or in the form of already evaluated information concerning the weight, position or the like. Due to a combination of the determined weight with information on the size and position, the seat occupation can be detected particularly precisely. Moreover, a weight determined subject to error e.g. due to an offset seating position can thus be corrected. For this purpose, a correction table can be stored in the storage medium, which assigns correction factors to various seating positions (e.g. further to the front, further to the rear). As in modern vehicles passenger cameras are installed more and more frequently, such a measure can be realized particularly easily. The control system 14 therefor is configured to receive the data related to the seat occupation based on the camera images, e.g. via an interface provided for this purpose.

In the following, the exemplary embodiment of the height adjustment device 12 will be explained in more detail.

The frame parts 100A, 100B of the seat part assembly 10 are connected to each other via the transverse tube 102 at a rear end. The transverse tube 102 (in this example) is pivotally mounted on the frame parts 100A, 100B and carries the associated rear swivel elements 121A, 121B.

In a front region a seat pan 101 is arranged on the frame parts 100A, 100B for forming a seating surface of the seat part assembly 10.

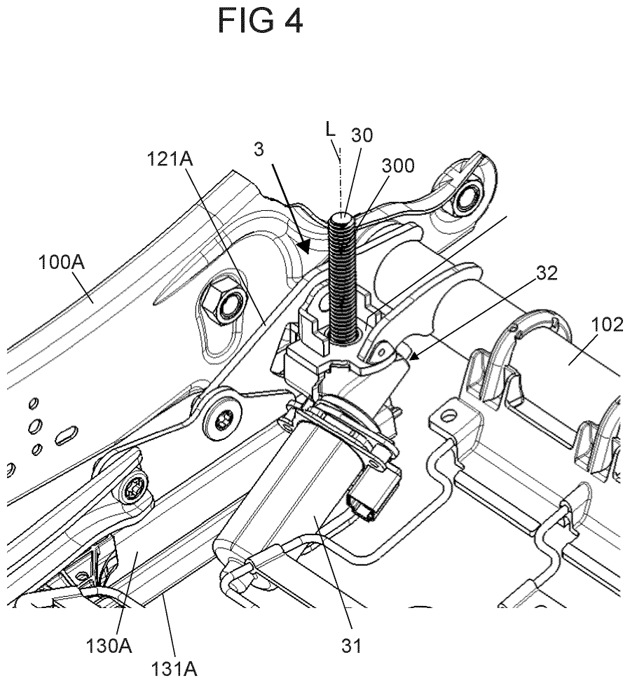

In the illustrated exemplary embodiment, the drive device 3 of the height adjustment device 12 by way of example is arranged on the rear swivel element 121A on the side of the guide rail pair 130A, 131A, as this can be taken from FIGS. 2 and 3 in a synopsis with FIG. 4. The drive device 3 is configured as a spindle drive and serves to introduce an adjusting force into the swivel element 121A so that by pivoting the swivel element 121A the swivel elements 120A, 121A, 120B, 121B are pivoted in their entirety and thereby the seat part assembly 10 can be adjusted in its vertical position, i.e. the distance between the seat part assembly 10 and the floor assembly 13 is adjusted.

At a set seat height the seat part assembly 10 is held in position at the swivel element 121A via the drive device 3. The drive device 3 therefor is designed to be so loadable that forces acting on the seat part assembly 10 can be absorbed and dissipated.

With reference to FIGS. 2 to 4 now the drive device 3 includes a spindle 30 which with one end is pivotally connected to the associated guide rail 130A via a bearing element.

The swivel element 121A is coupled to an attachment part connected to the guide rail 130A and pivotally mounted on the guide rail 130A via a bearing bolt.

With a threaded shank 300, on which an external thread is formed, the spindle 30 substantially perpendicularly extends from the end connected to the guide rail 130A. An adjusting gear unit 32 is operatively connected to the spindle 30 in such a way that by driving the adjusting gear unit 32 longitudinally along a direction of longitudinal extension L the same can be adjusted relative to the spindle 30 so as to change the length of a device between the adjusting gear unit 32 and the end of the spindle 30 pivotally mounted on the guide rail 130A and thereby introduce an adjusting force into the swivel element 121A and thus adjust the distance between the seat part assembly 10 and the floor assembly 13.

The adjusting gear unit 32 includes a spindle nut and a drive element in the form of a drive worm which via a worm toothing is in meshing engagement with an external toothing of the spindle nut. The drive element is driven via a drive motor 31 so that the spindle nut can be put into a rotary movement via the drive motor 31. The spindle nut is in threaded engagement with the external thread of the spindle 30 via an internal thread in such a way that by rotating the spindle nut rolls off on the spindle 30 and thereby is longitudinally adjusted relative to the spindle 30 along the longitudinal direction L.

Optionally, the height adjustment device 12 comprises a further drive motor 31 which can be arranged e.g. mirror-symmetrically relative to the drive motor 31 on the rear swivel element 121B on the side of the guide rail pair 130B, 131B. This is schematically illustrated in FIG. 3. Based on values of the current intensity of both drive motors, the acting weight can be determined particularly exactly.

The drive motors 31 are brushless direct current motors (BLDC motors) whose rotational speed and torque can be set particularly precisely.

The adjusting gear unit 32 is pivotally mounted on the swivel element 121A. During an adjusting movement in which the length of the portion of the spindle 30 extended between the adjusting gear unit 32 and the rail-side end is changed, the adjusting gear unit 32 thus can pivot on the swivel element 121A so as to compensate a change in position of the swivel element 121A with respect to the floor assembly 13.

The drive motor 31 is pivotally mounted on the swivel element 121A via the adjusting gear unit 32. During an adjusting movement of the swivel element 121A, the drive motor 31 and also the adjusting gear unit 32 thus are moved jointly with the swivel element 121A.

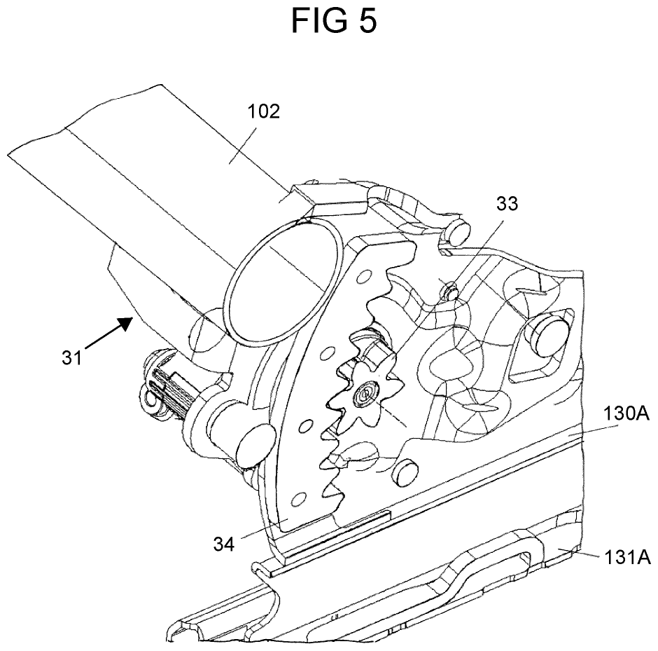

FIG. 5 by way of example shows an alternatively designed drive device for the vehicle seat of FIG. 1, which includes a drive motor 31 mounted on the seat part assembly 10, which drives a pinion 33 via a transmission. The pinion 33 meshes with a bent tooth segment 34 which is attached to the upper guide rail 130A. Moreover, the mode of operation is as described above.

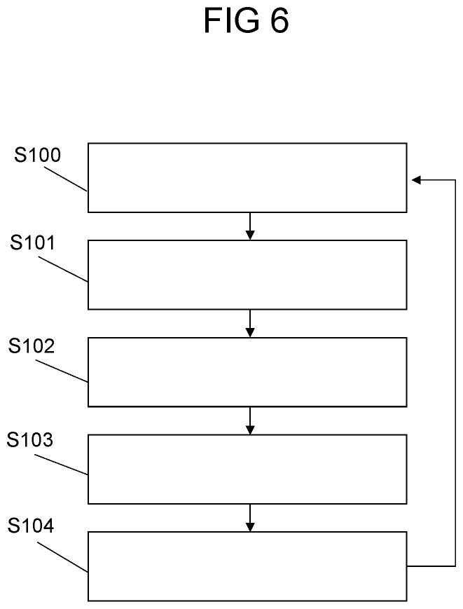

FIG. 6 shows a method for adjusting the vehicle seat 1, the method comprising the following steps:
Step S100: activating the drive device 3 of the height adjustment device 12 of the vehicle seat 1 for adjusting the distance between the seat part assembly 10 and the floor assembly 13 of the vehicle seat 1 in the first direction R1.
Step S101: detecting the value of the parameter (e.g. of the current intensity or the torque) of the drive device 3 during the adjustment in the first direction R1.
Step S102: activating the drive device 3 for adjusting the distance between the seat part assembly 10 and the floor assembly 13 in the second direction R2 opposite to the first direction R1.
Step S103: detecting the value of the parameter of the drive device 3 during the adjustment in the second direction R2.
Step S104: determining a weight acting on the seat part assembly based on the detected values of the parameter.

Optionally, the method periodically starts again at step S100, possibly with a (e.g. predetermined) delay between the steps S104 and S100.

With regard to specific embodiments of the method reference is made to the above information on the control system 14 in order to avoid repetitions. The method can comprise corresponding method steps which correspond to the mode of operation of the control system 14 described above.

In the storage medium 140 a computer program product is stored, comprising commands which on execution by the control system 14 cause the same to carry out the method described above.

### List of Reference Numerals

1 vehicle seat
10 seat part assembly
100A, 100B frame part
101 seat pan
102 transverse tube
11 backrest part assembly
12 height adjustment device
120A, 120B swivel element
121A, 121B swivel element
13 floor assembly (longitudinal adjustment device)
130A, 130B guide rail
131A, 131B guide rail
14 control system
140 storage medium
2 vehicle floor
3 drive device
30 spindle
300 threaded shank
31 drive motor
32 adjusting gear unit
33 pinion
34 tooth segment
4 camera
L direction of longitudinal extension
R1, R2 direction
X longitudinal direction
Y transverse direction
Z vertical direction

1. A vehicle seat comprising:
a seat part assembly,
a floor assembly carrying the seat part assembly,
a height adjustment device for adjusting a distance between the seat part assembly and the floor assembly by means of a drive device, and
a control system coupled to the drive device, which is adapted to carry out the following steps:
activating the drive device for adjusting the distance between the seat part assembly and the floor assembly in a first direction;
detecting a value of a parameter of the height adjustment device and/or the drive device during the adjustment in the first direction;
activating the drive device for adjusting the distance between the seat part assembly and the floor assembly in a second direction opposite to the first direction;
detecting a value of the parameter of at least one of the height adjustment device and the drive device during the adjustment in the second direction; and
determining a weight acting on the seat part assembly based on the detected values of the parameter.

2. The vehicle seat according to claim 1, wherein the parameter is at least one of an electrical parameter, a parameter that indicates a torque, and a parameter that indicates a rotational speed maximally reached during the adjustment.

3. The vehicle seat according to claim 1, wherein the parameter indicates an adjustment path covered within a particular time or an adjustment time needed for a particular adjustment path.

4. The vehicle seat according to claim 1, wherein the detection of the value of the parameter in at least one of the first direction and the second direction is effected within a period of a complete revolution of a gear stage of at least one of the height adjustment device and of the drive device.

5. The vehicle seat according to claim 1, wherein the control system is adapted to activate the drive device at least one of each for a predetermined time and each along a specified adjustment path in the first direction and in the second direction.

6. The vehicle seat according to claim 1, wherein the drive device is configured to be activated with different adjustment speeds and has a maximum adjustment speed, wherein the control system is adapted to activate the drive device with an adjustment speed in the first direction and in the second direction, which is lower than the maximum adjustment speed.

7. The vehicle seat according to claim 1, wherein the control system includes a storage medium in which a model is stored, which assigns a value of an acting weight to every possible value of the parameter.

8. The vehicle seat according to claim 7, wherein the model each assigns a value of an acting weight to every possible value of the parameter for several possible adjustment positions of the height adjustment device.

9. The vehicle seat according to claim 7, wherein the model each assigns a value of an acting weight to every possible value of the parameter with respect to an adjustment in the first direction and with respect to an adjustment in the second direction independently of each other.

10. The vehicle seat according to claim 1, wherein the control system is adapted to determine the acting weight each separately based on the detected value of the parameter for the first direction and based on the detected value of the parameter for the second direction and to determine the weight acting on the seat part assembly from the two values of the weight thus obtained.

11. The vehicle seat according to claim 1, wherein the drive device comprises a plurality of drive motors, wherein the control system is adapted to detect a value of a parameter during the adjustment for each of the plurality of drive motors and to determine the weight acting on the seat part assembly based on the detected values of the parameter of the plurality of drive motors.

12. The vehicle seat according to claim 1, wherein the control system is adapted to detect the values of the parameter for a calibration when no weight acts on the vehicle seat.

13. The vehicle seat according to claim 12, wherein the control system is adapted to automatically repeat the calibration after temporally specified intervals.

14. The vehicle seat according to claim 1, wherein the control system is adapted to receive data on a seat occupation of the vehicle seat from a detection device.

15. The vehicle seat according to claim 1, wherein at least one of
the control system is adapted to take account of a vehicle inclination when determining the weight acting on the seat part assembly, and
the control system is adapted to take account of a temperature when determining the weight acting on the seat part assembly.

16. (canceled)

17. The vehicle seat according to claim 1, wherein the control system is adapted to take account of a setting of another seat adjustment device, when determining the weight acting on the seat part assembly.

18. The vehicle seat according to claim 1, wherein the control system is adapted to recognize whether at least one of the vehicle seat and a passenger sitting thereon moves during the detection of the value of the parameter of at least one the height adjustment device and of the drive device in at least one of the first direction and the second direction due to a further action of force.

19. The vehicle seat according to claim 1, wherein the control system comprises a memory in which a model is retrievably stored, the model establishing relationships between the weight acting on the seat part assembly, a seat adjustment position, and the value of the measured parameter.

20. (canceled)

21. (canceled)

22. A method for determining a weight acting on a vehicle seat comprising the following steps:
activating a drive device of a height adjustment device of the vehicle seat for adjusting a distance between a seat part assembly and a floor assembly of the vehicle seat in a first direction;
detecting a value of a parameter of at least one of the height adjustment device and the drive device during the adjustment in the first direction;
activating the drive device for adjusting the distance between the seat part assembly and the floor assembly in a second direction opposite to the first direction;
detecting a value of the parameter of at least one of the height adjustment device and the drive device during the adjustment in the second direction; and
determining the weight acting on the seat part assembly based on the detected values of the parameter.

23. (canceled)

24. A non-volatile computer-readable storage medium on which commands are stored, which on execution by one or more computers cause the same to carry out the method according to claim 22.
